(19) United States
(12) Patent Application Publication
(10) Pub. No.: US 2019/0266738 A1
(43) Pub. Date: Aug. 29, 2019

(54) MOBILE TERMINAL AND METHOD FOR CONTROLLING THE SAME

(71) Applicant: LG ELECTRONICS INC., Seoul (KR)

(72) Inventors: Minho KIM, Seoul (KR); Yehan AHN, Seoul (KR)

(73) Assignee: LG ELECTRONICS INC., Seoul (KR)

(21) Appl. No.: 16/007,676

(22) Filed: Jun. 13, 2018

(30) Foreign Application Priority Data
Feb. 26, 2018 (KR) 10-2018-0022910

(51) Int. Cl. G06T 7/50; G06K 9/00; G06F 3/01

(52) U.S. Cl. CPC G06T 7/50; G06K 9/00288; G06T 2207/30201; G06K 9/00248; G06F 3/012; G06K 9/00255

(57) ABSTRACT

A method for controlling a device, and which includes capturing, via a depth camera of the device, depth image data of a user; detecting, via a controller of the device, a face area by analyzing the depth image data of the user; extracting, via the controller, a specific point from the detected face area; determining, via the controller, a direction the user is facing with respect to the device based on a position relationship between the extracted specific point and a reference point; and changing, via the controller, a state of the device based on the determined direction the user is facing with respect to the device.

Pursuant to 35 U.S.C. § 119(a), this application claims the benefit of earlier filing date and right of priority to Korean Application No. 10-2018-0022910, filed on Feb. 26, 2018, the contents of which are hereby incorporated by reference herein in their entirety.

### BACKGROUND OF THE INVENTION

### Field of the Invention

The present invention relates to a mobile terminal and method for controlling the same. More particularly, the invention can be applied to the technical field of detecting user's intention to control the mobile terminal rapidly and accurately using a depth camera with a rapid and accurate algorithm.

### Discussion of the Related Art

Generally, terminals can be classified as mobile/portable terminals and stationary terminals. The mobile terminals can be further classified as handheld terminals and vehicle mount terminals'.

The mobile terminals have become increasingly more functional. Examples of such functions include data and voice communication, image and video capturing through a camera, voice recording, music file playback through a speaker system, and image and video displaying through a display unit. Some mobile terminals include additional functions for supporting game playing and working as multimedia players. In particular, current mobile terminals can receive multicast signals including visual contents such as videos and television programs.

In addition, various types of artificial intelligence devices have been developed with the advance of the artificial intelligence technology. Basically, these devices have adopted, as an input method for interacting with their users, three types of input methods such as vision, hearing (voice recognition), and touch. However, in the case of voice recognition input, a recognition rate is not sufficiently high, and a relevant device cannot determine by itself the purpose of voice. For example, such a device has a problem in that a conversation between two people may be recognized as a voice command. In the case of touch input, there is inconvenience in that a user should approach a relevant device every time. In addition, by physical contact, a location of the device may be changed, or the device may fall down unintentionally. Therefore, much attention has been attracted to the vision-based interaction technology capable of overcoming the disadvantages of the voice recognition and touch input. In particular, a face detection technology has been taken as a representative example.

However, the conventional face detection technology has the following problems. To implement a face tracking algorithm, an RGB camera has been generally used in the prior art. In particular, in the case of the RGB camera, since image data is segmented based on color difference or contrast, its processing speed and accuracy are lower than those of a depth camera. In addition, when the RGB camera is used, it is difficult to obtain the amount of indentation of an object and a distance between the camera and object when the RGB camera is used, and thus, a complex algorithm that requires a large amount of calculation should be used. For these reasons, it is difficult to implement high-speed tracking. Further, considering that the RGB camera is significantly affected by illumination, accurate face recognition cannot be achieved in a low illumination environment.

### SUMMARY OF THE INVENTION

Accordingly, the object of the present invention is to solve the above-described problems and other problems which will be described later.

In an embodiment of the present invention, provided is a solution for achieving high-speed close-range face tracking using a depth camera.

In another embodiment of the present invention, provided is a technology for rapidly detecting a position of a nose tip from a face using a depth camera.

In a further embodiment of the present invention, provided is various UX/UI technologies available after high-speed face detection is performed.

To achieve these objects and other advantages, in an aspect of the present invention, provided herein is a method for controlling a device with a depth camera, including: capturing at least one user using the depth camera; detecting a face area by analyzing an image of the captured user in accordance with at least one command stored in a memory; extracting a specific point from the detected face area in accordance with the at least one command stored in the memory; determining directivity of the at least one user based on a position relationship between the extracted specific point and a reference point in accordance with the at least one command stored in the memory; and changing a state of the device based on the directivity determination result in accordance with the at least one command stored in the memory.

In another aspect of the present invention, provided herein is a device with a depth camera, including: a memory configured to store at least one command; the depth camera configured to capture at least one user; a display module; and a controller configured to control the memory, the depth camera, and the display module. In particular, the controller may be configured to: capture the at least one user by controlling the depth camera; determine a direction of the captured user in accordance with the at least one command stored in the memory; and display, on the display module, different video data according to the determined user direction.

Accordingly, the mobile terminal and method for controlling the same provide several advantages.

According to an embodiment of the present invention, a solution for achieving high-speed close-range face tracking using a depth camera can be provided.

According to another embodiment of the present invention, a technology for rapidly detecting a position of a nose tip from a face using a depth camera can be provided.

According to a further embodiment of the present invention, various UX/UI technologies available after high-speed face detection is performed can be provided. That is, after detection of a user's face, a graphic interface including various menus can be rapidly provided.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1A is a block diagram of a mobile terminal according to an embodiment of the present disclosure.

FIGS. 1B and 1C are conceptual views of one example of the mobile terminal, viewed from different directions;

FIG. 2 is a conceptual view of a deformable mobile terminal according to an alternative embodiment of the present disclosure.

FIG. 3 is a block diagram illustrating essential components of a device according to an embodiment of the present invention.

FIG. 4 is a flowchart illustrating a method for controlling the device according to an embodiment of the present invention.

FIG. 5 is a diagram illustrating a plurality of pieces of image data analyzed in main steps among the steps shown in FIG. 4.

FIG. 6 is a sub-flowchart illustrating in detail step S450 shown in FIG. 4.

FIG. 7 illustrates image data to explain a result obtained by distinguishing between a face candidate area and a body area in FIG. 6.

FIG. 8 illustrates histograms used to distinguish between a face candidate area and a body area in FIG. 6.

FIG. 9 is a first sub-flowchart illustrating in detail step S460 shown in FIG. 4.

FIG. 10 illustrates image data to explain a result obtained by determining a final face area from a face candidate area.

FIG. 11 is a second sub-flowchart illustrating in detail step S460 shown in FIG. 4.

FIG. 12 is a first sub-flowchart illustrating in detail step S470 shown in FIG. 4.

FIG. 13 is a second sub-flowchart illustrating in detail step S470 shown in FIG. 4.

FIG. 14 is a diagram illustrating image data for determining left and right directivity of a face and a determination method.

FIG. 15 is a diagram illustrating image data for determining up and down directivity of a face and a determination method.

FIG. 16 is a diagram illustrating a process for rotating a face image in an up-and-down direction such that a forehead and a chin are perpendicular and a calculation formula therefor.

FIG. 17 is a diagram illustrating reference points applicable to the present invention.

FIG. 18 is a sub-flowchart illustrating in detail step S491 shown in FIG. 4.

FIG. 19 is a diagram illustrating comparison between a node tip before adjustment and a nose tip after adjustment.

FIG. 20 is a diagram illustrating a process for determining the final validity of data according to face directions and a calculation formula therefor.

FIG. 21 is a diagram illustrating a process for identifying a user that desires to control the device according to an embodiment of the present invention.

FIG. 22 is a diagram illustrating an example where the device changes its state according to directions of a user that desires to control the device according to an embodiment of the present invention.

FIG. 23 is a diagram illustrating another example where the device changes its state according to directions of a user that desires to control the device according to an embodiment of the present invention.

FIG. 24 is a diagram illustrating a solution for the case when a plurality of users desire to control the device according to an embodiment of the present invention.

FIG. 25 is a diagram illustrating a further example where the device changes its state according to directions of a user that desires to control the device according to an embodiment of the present invention.

FIG. 26 is a diagram illustrating still another example where the device changes its state according to directions of a user that desires to control the device according to an embodiment of the present invention.

FIG. 27 is a diagram illustrating an example of metadata for changing the state of the device according to directions of a user that desires to control the device according to an embodiment of the present invention.

FIG. 28 is a diagram illustrating another example of metadata for changing the state of the device according to directions of a user that desires to control the device according to an embodiment of the present invention.

FIG. 29 is a flowchart illustrating a method for controlling the device according to another embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a term such as “module” and “unit” may be used to refer to elements or components. Use of such a term herein is merely intended to facilitate description of the specification, and the term itself is not intended to give any special meaning or function. The accompanying drawings are used to help easily understand various technical features and it should be understood that the embodiments presented herein are not limited by the accompanying drawings. As such, the present invention should be construed to extend to any alterations, equivalents and substitutes in addition to those which are particularly set out in the accompanying drawings.

Although the terms first, second, etc. may be used herein to describe various elements, and these elements should not be limited by these terms. These terms are generally only used to distinguish one element from another. When an element is referred to as being “connected with” or “accessed by” another element, the element can be directly connected with or accessed by the other element or intervening elements may also be present. In contrast, when an element is referred to as being “directly connected with” or “directly accessed by” another element, there are no intervening elements present.

A singular representation may include a plural representation unless it represents a definitely different meaning from the context. Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present application includes a combination of features, numerals, steps, operations, components, parts and the like partially omitted from the related or involved features, numerals, steps, operations, components and parts described using the aforementioned terms unless deviating from the intentions of the disclosed original invention.

Mobile terminals presented herein may be implemented using a variety of different types of terminals. Examples of such terminals may include cellular phones, smart phones, laptop computers, digital broadcast terminals, personal digital assistants (PDAs), portable multimedia players (PMPs), navigators, slate PCs, tablet PCs, ultrabooks, wearable devices (for example, smart watches, smart glasses, head mounted displays (HMDs)), and the like.

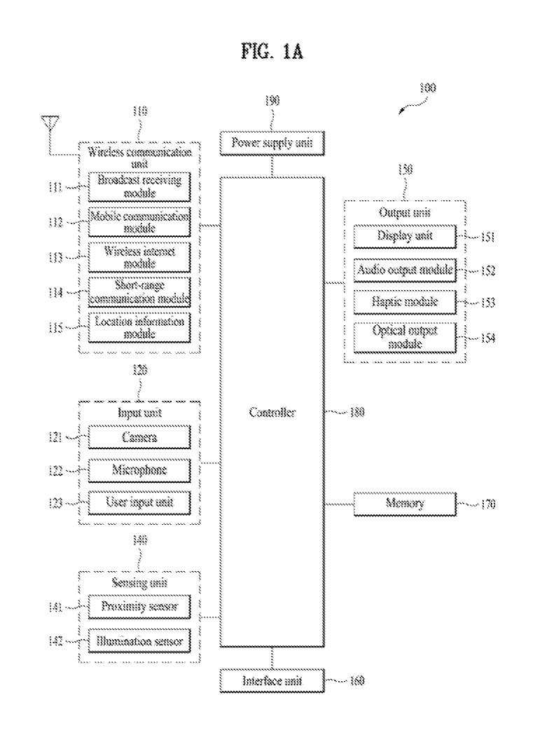

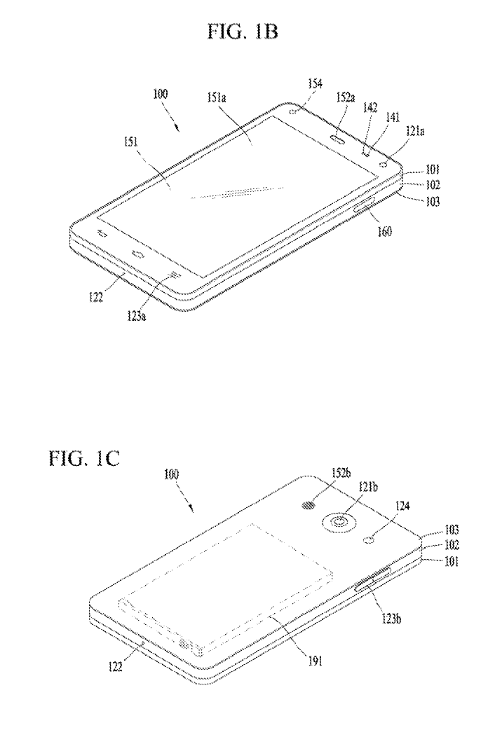

By way of non-limiting example only, further description will be made with reference to particular types of mobile terminals. However, such teachings apply equally to other types of stationary terminals such as digital TVs, desktop computers, digital signage players and the like. Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this instance, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a. The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

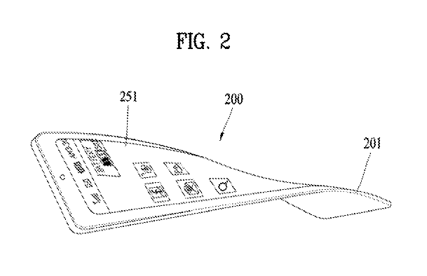

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously. The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When the flexible display unit 251 is not deformed (for example, in a state with an infinite radius of curvature and referred to as a first state), a display region of the flexible display unit 251 includes a generally flat surface. When the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized so a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 can transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

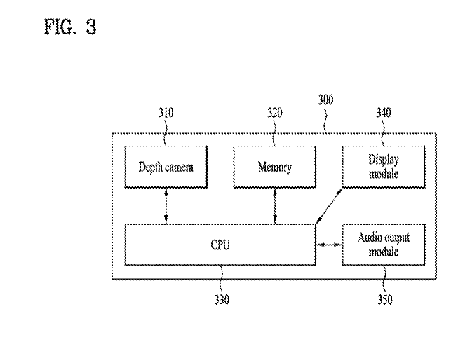

FIG. 3 is a block diagram illustrating components of the device according to an embodiment of the present invention. The device 300 shown in FIG. 3 may not only correspond to one of the mobile terminals illustrated in FIGS. 1 and 2 but also include any types of display devices with a depth camera including a mobile device, a TV, and the like.

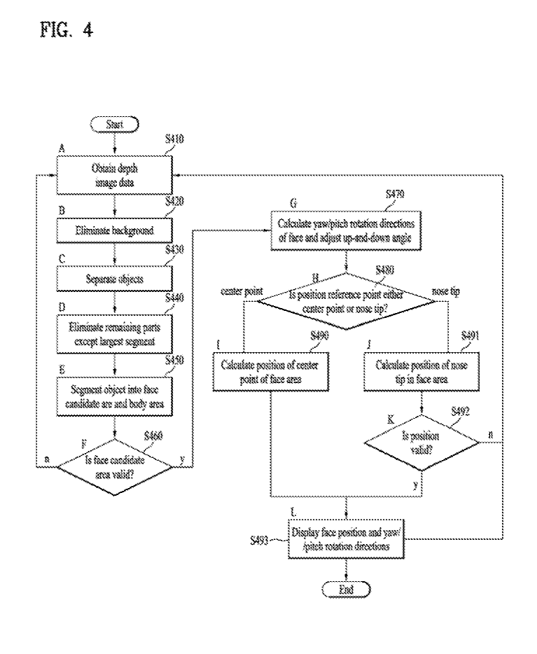

A memory 320 is configured to store at least one command. For example, the at least one command may include at least one step among steps of the algorithm shown in FIG. 4. A depth camera 310 is configured to capture at least one user. In addition, a display module 340 and an audio output module 350 are configured to output relevant data as a result. The depth camera 310 may correspond to a sensor for detecting depth information using, for example, at least one of a time of flight (TOF), a stereoscopic vision, and a structured light pattern.

A controller (CPU) 330 is configured to control the memory 320, depth camera 310, display module 340, and audio output module 350. In particular, the controller 330 may capture the at least one user by controlling the depth camera 310, determine a direction of the captured user in accordance with the at least one command stored in the memory 320, and display, on the display module 340, different video data according to the determined user direction.

In addition, when a plurality of users are detected, the controller 330 analyzes, as a target user, only a specific user among the recognized plurality of users based on depth information or timing information. Further, the controller 330 switches the target user based on the depth information or timing information. Details will be described later with reference to FIG. 28.

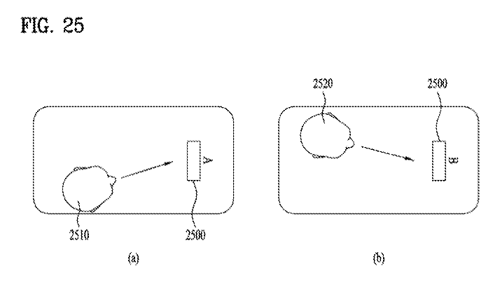

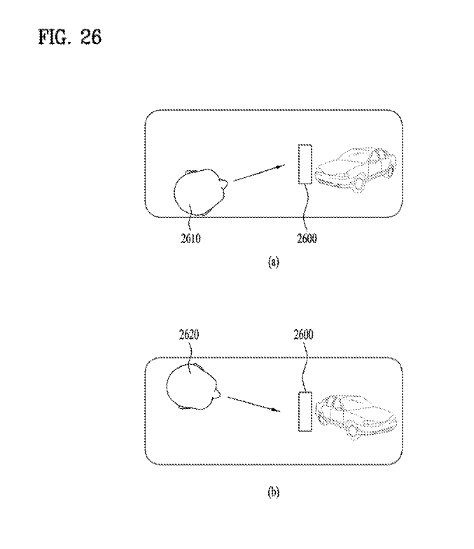

When it is determined that the user direction is toward the device, the controller 330 triggers a voice command function of the device or an unlock function through face recognition. Details will be described later with reference to FIG. 23. When it is determined that the user direction is toward the device, the controller 330 changes video data to be displayed according to left and right directivity between the user and device. Details will be described later with reference to FIGS. 25 and 26.

The memory 320 includes a first command for detecting a face area by analyzing an image of the captured user, a second command for extracting a specific point from the detected face area, and a third command for determining directivity of the at least one user according to a position relationship between the extracted specific point and a reference point.

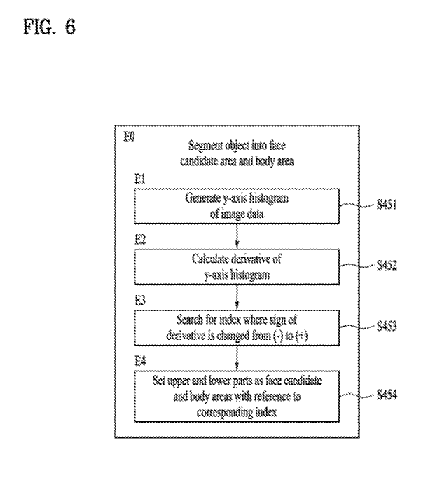

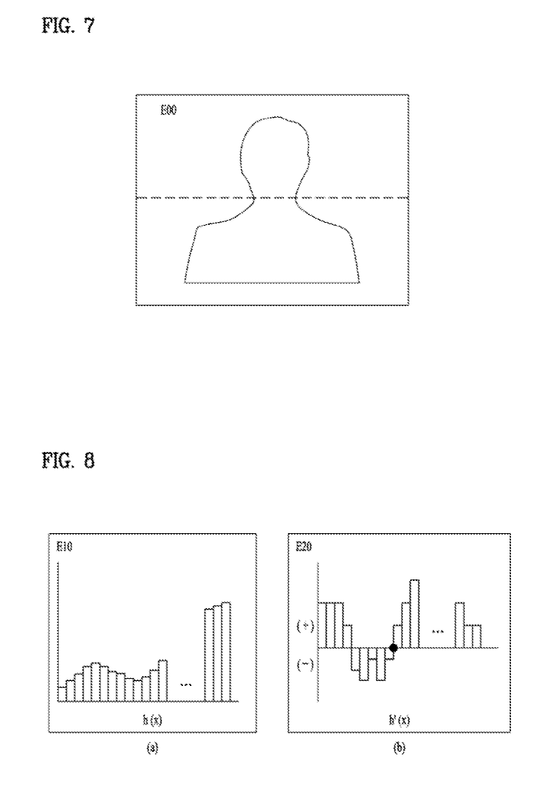

For example, the first command further includes an instruction to extract a face candidate area from among objects in the image of the captured user exists and if a specific index exists in the extracted face candidate area, an instruction to consider that a face of the captured user is directed to the device. For example, the specific index corresponds to a point in the face candidate area where a change in the depth value on the x-axis is equal to or greater than a predetermined threshold value. Details will be described later with reference to FIGS. 6 and 7.

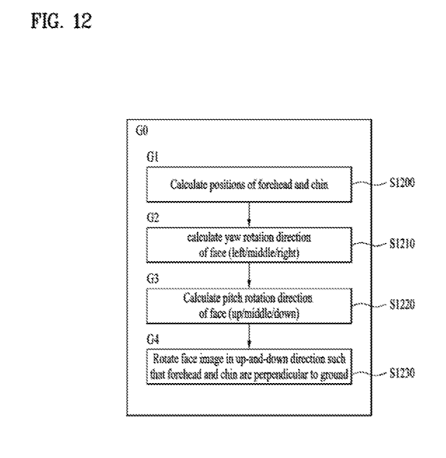

Further, the second command further includes an instruction to calculate a position of a forehead and a position of a chin in the detected face area, an instruction to determine a z-axis rotation direction and a y-axis rotation direction of the face of the user based on the calculated positions of the forehead and chin, and an instruction to readjust z-values among position values of individual points in the detected face area such that the calculated positions of the forehead and chin are perpendicular to the ground. Details will be described later with reference to FIGS. 12 to 16.

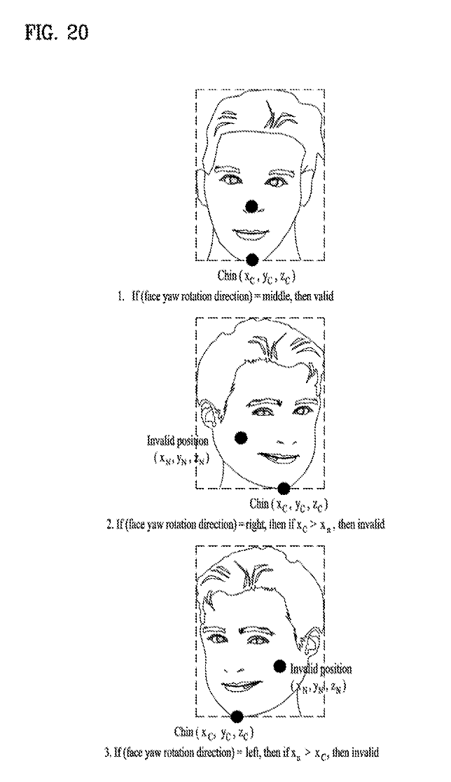

If a difference between an x-coordinate value of a specific point, which is determined to be closest to the device, and an x-coordinate value of the chin corresponding to a reference point is equal to or greater than a predetermined value, the third command further includes an instruction to consider that the face of the user is directed to the device. Further, if the difference between the x-coordinate value of the specific point, which is determined to be closest to the device, and the x-coordinate value of the chin corresponding to the reference point is smaller than the predetermined value, the third command further includes an instruction to consider that the face of the user is not directed to the device. Details will be described later with reference to FIG. 20.

Next, FIG. 4 is a flowchart illustrating a method for controlling the device according to an embodiment of the present invention. It should be appreciated by those skilled in the art that other embodiments may be implemented using the embodiments of FIGS. 3 and 4.

Before describing the embodiment of FIG. 4, the features of the present invention are described in brief. To implement the vision-based interaction, a desired partial image can be extracted (segmented) from an entire image, and a depth value (i.e., a distance between the device and user on the z-axis) that can be obtained by the depth camera is used in the present invention. When using a depth value, it is possible to separate individual objects which are not connected to each other, estimate the indentation of an object, and extract a point of the object closest to the camera. That is, the face and nose tip of the user can be calculated very rapidly.

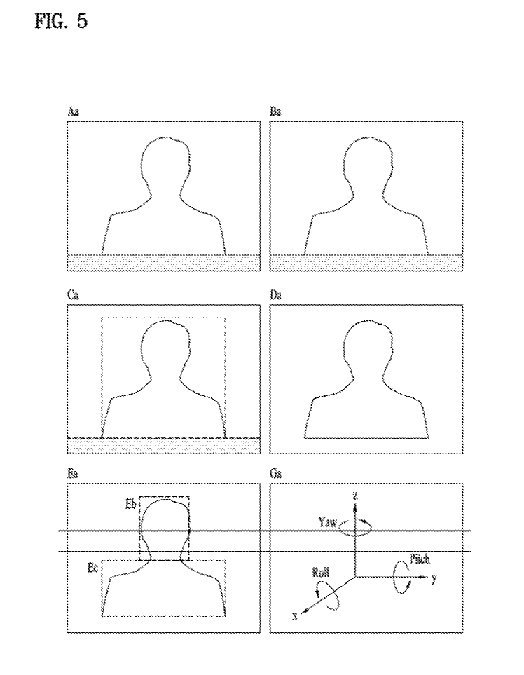

Referring to FIG. 4, the device according to an embodiment of the present invention obtains depth image data through the depth camera (S410). The obtained data has a size corresponding to the number of pixels of the camera (resolution), and each value means a depth value of the corresponding pixel. The relevant data is illustrated in Aa of FIG. 5.

Next, the device eliminates data related to background, which is located away from the device, using the depth value (on the z-axis) (S420). Since the image data obtained in step S410 includes various objects, the background image data needs to be eliminated to extract an interesting object (e.g., user). The relevant data is illustrated in Ba of FIG. 5.

Although the background image is eliminated from the entire image in step S420, there may remain other non-interesting objects. Thus, the device separates individual objects which are not connected to each other using the depth value (S430). The relevant data is illustrated in Ca of FIG. 5. Thereafter, the device assumes that the largest segment among the separated segments is a person and then eliminates the remaining parts except the largest segment (S440). The relevant data is illustrated in Da of FIG. 5.

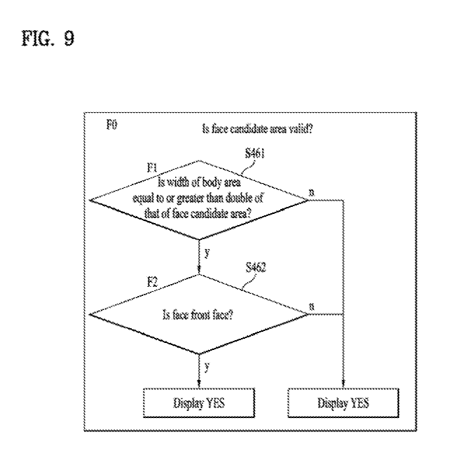

The device segments the remaining object obtained in step S440 into a face candidate are and a body area (S450). The relevant data is illustrated in Ea of FIG. 5. Details will be described later with reference to FIGS. 6 to 8. The device determines the validity of the face candidate area (shown in Eb of FIG. 5) obtained in step S450 (S460). This is because to enable the device to operate only when the user faces the device, and it will be described in detail with reference to FIGS. 9 to 11.

Thereafter, the device calculates yaw/pitch rotation directions of the recognized user's face and then adjust an up-and-down angle thereof. In this specification, roll/pitch/yaw rotation, which is commonly used by those skilled in the art, means the degree of rotation on x/y/z axes as shown in Ga of FIG. 5.

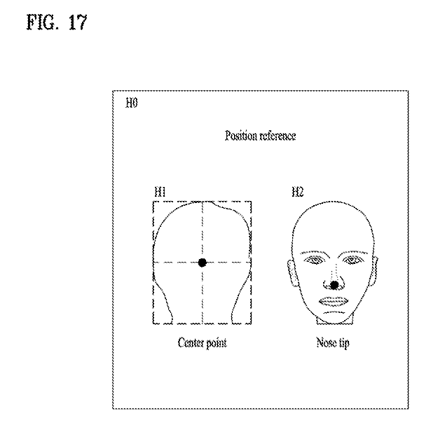

The device determines whether a position reference point of the face is either the center point of the face area or the nose tip in the face area (S480). The position reference point can be commonly determined by the provider according to a menu, UX/UI type, etc., or it can be manually configured by the user. The both cases are within the scope of the present invention. It will be described later in detail reference to FIG. 17.

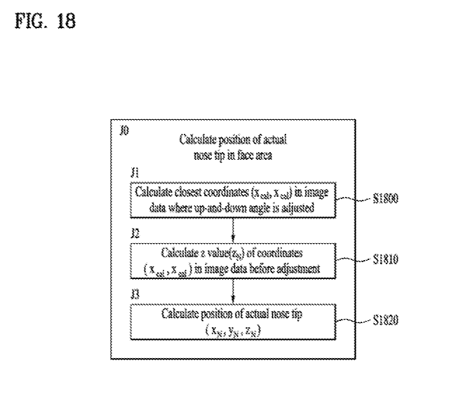

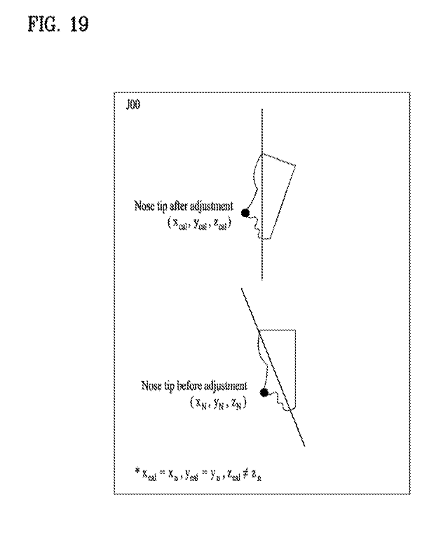

When it is determined in step S480 that the position reference point of the face corresponds to the center point of the face, the device calculates a position of the center point of the face area (S490). Further, when it is determined in step S480 that the position reference point of the face corresponds to the nose tip in the face area, the device calculates a position of the nose tip in the face area (S491). Subsequently, the device determines whether the position is valid or not (S492). Details of step S491 will be described later with reference to FIGS. 18 and 19, and details of step S492 will be described later with reference to FIG. 20. Finally, the device displays the position of the face and yaw/pitch rotation directions (S493) and then returns to step S410.

Next, FIG. 6 is a sub-flowchart illustrating in detail step S450 shown in FIG. 4. Specifically, FIG. 6 shows a particular algorithm for segmenting an object into face candidate and body areas. First, the device generates a y-axis histogram of image data (S451). This is illustrated in FIG. 8 (a). Then, the device calculates a derivative of the y-axis histogram (S452). This is illustrated in FIG. 8 (b).

Next, the device calculates an index where the sign of the derivative is changed from (−) to (+) as shown in FIG. 8 (b) (S453). The device may set upper and lower parts as the face candidate and body areas with reference to the corresponding index (S454). It can be interpreted to mean that the bottom line of the neck (i.e., the top line of the shoulders) is set to a reference line for separating the face and body like the image of FIG. 7. This is because the corresponding index can be considered as a point where the value of the y-axis histogram (the sum of the number of pieces of valid data on the x-axis) is changed from decrease to increase.

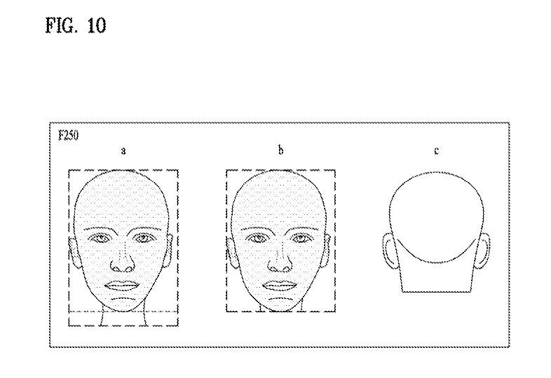

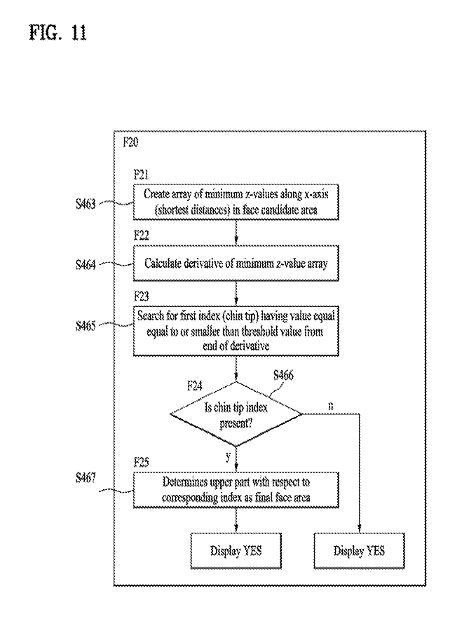

Next, FIG. 9 is a first sub-flowchart illustrating in detail step S460 shown in FIG. 4, FIG. 10 illustrates image data to explain a result obtained by determining a final face area from the face candidate area, and FIG. 11 is a second sub-flowchart illustrating in detail step S460 shown in FIG. 4. Specifically, FIG. 9 shows a process for determining whether the face candidate area is valid, and FIG. 11 is a process for determining whether the face is a front face.

As shown in FIG. 9, the device examines whether two conditions are satisfied in order to determine the validity of the face candidate area. First, the device determines whether the width of the body area is equal to or greater than double of that of the face candidate area (S461). However, in this instance, an area may be used as the reference instead of a width, and the numerical value (i.e., double) may vary depending on users. In other words, it is apparent that such changes are within the scope of the present invention.

When it is determined in step S461 that the width of the body area is equal to or greater than double of that of the face candidate area, the device determines whether the face is the front face (S462). This is because to allow the device to determine that the user desires to interact with the device only when the user's face is directed to the device. In other words, when both the conditions (i.e., steps) of S461 and S462 are satisfied, the device determines the final face area.

FIG. 11 shows a process for determining whether the valid face candidate area shown in FIG. 9 corresponds to the front face. The device creates an array of minimum z-values along the x-axis (i.e., a minimum distance between each point and the device) in the face candidate area (S463) and calculates a derivative of the minimum z-value array (S464).

Next, the device searches for a first index (e.g., chin tip) having a value equal to or smaller than a threshold value from the end of the derivative (S465). The device determines whether the chin tip index is present (S466). When it is determined in step S466 that the chin tip index is present, the device determines an upper part with respect to the corresponding index as the final face area (S467).

This corresponds to the principle of performing a search using a depth different between the neck and chin (i.e., a first point where a value sharply decreases from the lowest end of an array of minimum values on the x-axis). First, the device creates an array of minimum values (i.e., closest distances) on the x-axis and calculates a derivative of the created minimum value array. Thereafter, the device searches for a first index having a value equal to or smaller than a threshold value (i.e., threshold value with respect to the depth difference between the neck and chin) from the end of the derivative and then considers the searched index as a y-coordinate of the chin tip ((a) or (b) of FIG. 10). Further, in the case of a back face, the z-value increases or decreases without sharp fluctuation as shown in FIG. 10 (c).

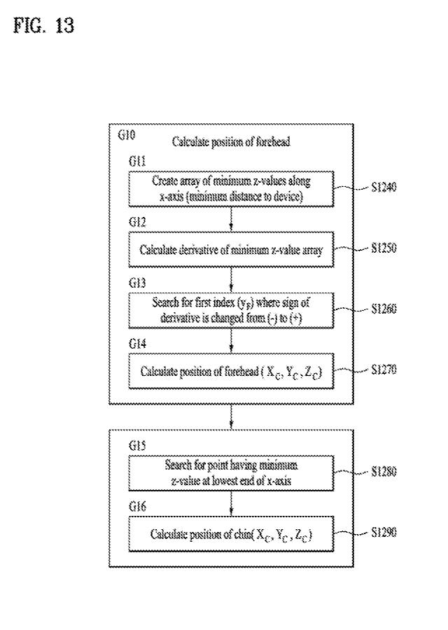

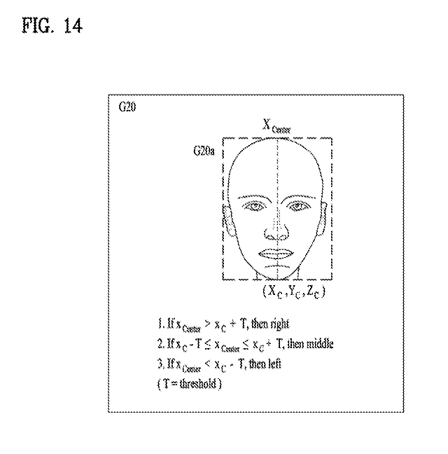

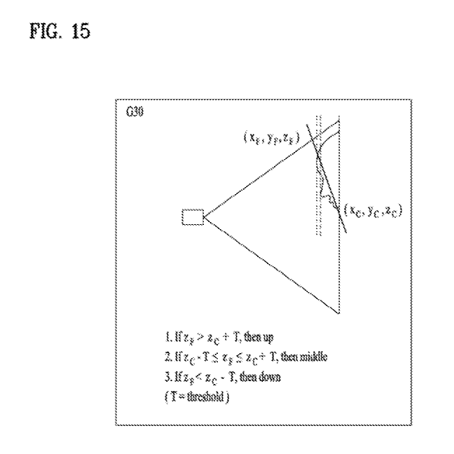

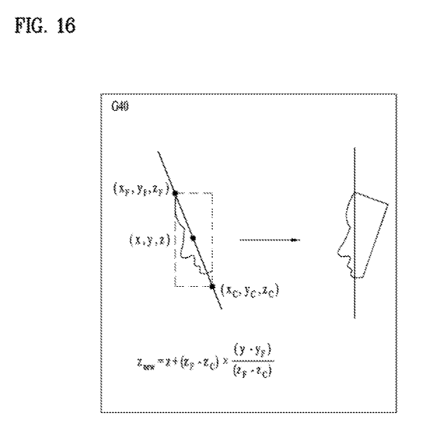

FIG. 12 is a first sub-flowchart illustrating in detail step S470 shown in FIG. 4, and FIG. 13 is a second sub-flowchart illustrating in detail step S470 shown in FIG. 4. FIG. 14 is a diagram illustrating image data for determining left and right directivity of the face and a determination method, and FIG. 15 is a diagram illustrating image data for determining up and down directivity of the face and a determination method. FIG. 16 is a diagram illustrating a process for rotating a face image in an up-and-down direction such that the forehead and chin are perpendicular to the ground and a calculation formula therefor.

First, as shown in FIG. 12, the device calculates the positions of the forehead and chin (S1200), calculates the yaw rotation direction of the face (i.e., left/middle/right) (S1210), calculates the pitch rotation direction of the face (i.e., up/middle/down) (S1220), and rotates the face image in the up-and-down direction such that the forehead and chin are perpendicular to the ground (S1230). As a preprocessing process for calculating the position of the nose tip, step S1230 is one of the major features of the present invention. Although there have been several algorithms for finding the nose in the face area, the present invention provides a novel algorithm shown in FIG. 18 to enable the high-speed tracking by reducing the amount of calculation. In addition, it is possible to handle when the forehead is closer to the device than the nose because the user looks down at the device or when the chin is closer to the device than the nose because the user looks up at the device. Specifically, it is confirmed experimentally that when the device finds the closest point after performing the preprocessing process, i.e., after adjusting an up-and-down angle of the face as if the user looks straight ahead, the corresponding point is always the nose tip.

Hereinafter, the main steps of FIG. 12 will be described in detail. In particular, FIG. 13 illustrates in detail the main steps of FIG. 12. The position (xF, yF, zF) of the forehead is a first point where in the array of minimum values on the x-axis, a value is changed from decrease to increase. First, the device creates an array of minimum z-values along the x-axis (i.e., a minimum distance to the device) (S1240) and calculates a derivative of the created minimum value array (S1250).

Next, the device searches for a first index where the sign of the derivative is changed from (−) to (+) (S1260). In this instance, the searched index corresponds to the y-coordinate (yF) of the forehead, and the value of the corresponding index corresponds to the z-coordinate (zF) of the forehead. In addition, by finding a point having a value on the x-axis set to zF where the y-coordinate is yF. By doing so, the device can calculate the position (xF, yF, zF) of the forehead (S1270).

In addition, to calculate the position of the chin, the device searches for a point having the minimum z-value at the lowest end of the x-axis (i.e., minimum distance to the device) (S1280) and then calculates the position (xC, yC, zC) of the chin (S1290).

In addition, as shown in FIG. 20, the device may use the coordinates (xC, yC, zC) of the chin in the face area to calculate the yaw rotation direction of the face. Specifically, referring to FIG. 20, when the coordinates (xC, yC, zC) of the chin are located on the right side with respect to the center point (Xcenter) of the face area, the device may determine that the face is turned to the right. On the contrary, when the coordinates (xC, yC, zC) of the chin are located on the left side, the device may determine that the face is turned to the left. Moreover, when the coordinates (xC, yC, zC) of the chin is located on the same line with the center point (Xcenter), the device may determine that the direction of the face is ‘middle’, i.e., the user's face is directed to the device. To consider a case when the face is slightly turned to the left or right as ‘middle’, it is possible to apply a threshold, T, and this can be expressed as shown in the following formula.

If x_{Center}>x_{C}+T, then Right 1.

If x_{C}−T≤x_{Center}≤x_{C}+T, then Middle 2.

If x_{Center}<x_{C}−T, then Left 3.
(T=threshold)

Moreover, the device may use the relationship between the positions of the forehead and chin calculated with reference to FIG. 13 to calculate the pitch rotation direction of the face. As shown in FIG. 15, when the forehead (xF, yF, zF) is in front of the chin (xC, yC, zC), the device may determine that the user looks down at the device. When the chin is in front of the forehead, the device may determine that the user looks up at the device. Further, when the forehead and chin are located on the same line, the device may determine that the direction of the face is ‘middle’, i.e., the user's face is directed to the device. To consider a case when the user looks up or down at the device at a small angle as ‘middle’, it is possible to apply a threshold, T, and this can be expressed as shown in the following formula.

If zF>zC+T, then up 1.

If zC−T≤zF≤xC+T, then Middle 2.

If xF<xC−T, then Down 3.
(T=threshold)

Finally, the device needs to perform adjustment such that the forehead and chin are perpendicular to the ground as described above. Thus, if z-values of all points between the forehead and chin are adjusted as Znew in proportion to a slope between the forehead and chin, it is possible to set the direction of the face as if the user looks straight ahead. At each point, the value of Znew can be calculated according to the following equation.

$${z}_{new} = z + ( {z}_{F} - {z}_{C} ) \times \frac{( y - {y}_{F} )}{( {y}_{C} - {y}_{F} )}$$

FIG. 17 is a diagram illustrating reference points applicable to the present invention. To determine whether the user faces to the device, either the center point (H1) or the nose tip (H2) may be used as the reference point. Here, the center point (H1) can be simply defined as the center point on the x-y plane of the face area. In the case of the nose tip, a method for rapidly calculating the nose tip in the face area will be described in detail with reference to FIGS. 18 to 20.

FIG. 18 is a sub-flowchart illustrating in detail step S491 shown in FIG. 4, FIG. 19 is a diagram illustrating comparison between a node tip before adjustment and a nose tip after adjustment, and FIG. 20 is a diagram illustrating a process for determining the final validity of data according to face directions and a calculation formula therefor.

As shown in FIG. 19, x and y coordinates (Xcal, Ycal) of the nose tip in the adjusted image of FIG. 16 are the same as those (Xn, Yn) of the nose tip before the adjustment, and a z coordinate (Zcal) of the adjusted image is different from that (Zn) of the nose tip before the adjustment. Thus, the device calculates the x and y coordinates (Xcal, Ycal) of the closest point (i.e., point with the smallest value of Zcal) in the image data where the up-and-down angle is adjusted (S1800).

Next, by calculating the value (Zn) corresponding to the x and y coordinates (Xcal, Ycal) in the image data before the adjustment (S1810), the device can calculate the position (Xn, Yn, Zn) of the nose tip (S1820). In this instance, a relationship between the nose tip after the adjustment (Xcal, Ycal, Zcal) and the nose tip before the adjustment (Xn, Yn, Zn) can be defined as shown in the following formula.

x_{cal}=xₙ, y_{cal}=yₙ, z_{cal}≠zₙ

In the case, although the device completes the calculation of the position of the nose tip as shown in FIG. 18, the device should check its validity. This is because when the user turns his or her face to the left or right at a predetermined angle or more, other parts such as a cheekbone, etc. may be located close to the device than the nose tip as shown in FIG. 20. In other words, even when the closest point is not the nose tip, the device may recognize the nose tip as the closest point in the steps of FIG. 18.

If the yaw rotation direction of the face calculated in FIG. 14 is ‘middle’, it is always valid because the nose tip (Xn, Yn, Zn) is the closest point. If the yaw rotation direction of the face is ‘right’, it is valid only when the nose tip (Xn, Yn, Zn) is located on the right compared to the chin (Xc, Yc, Zc). If the yaw rotation direction of the face is ‘left’, it is valid only when the nose tip (Xn, Yn, Zn) is located on the left compared to the chin (Xc, Yc, Zc). This can be expressed as shown in the following formula.

If (face yaw rotation direction)=Middle, then it is valid 1.

If (face yaw rotation direction)=Right, then if xC>xn, then it is invalid 2.

If (face yaw rotation direction)=Left, then if xn>xC, then it is invalid 3.

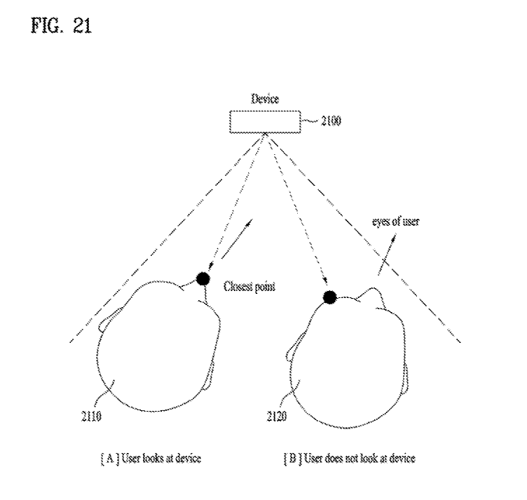

FIG. 21 is a diagram illustrating a process for identifying a user that desires to control the device according to an embodiment of the present invention. Only when a user 2110 looks at a device 2100 as shown in FIG. 21 (a), the validity conditions described in FIG. 20 can be satisfied. Therefore, according to the algorithm of the present invention, the device 2100 can determine that the user 2110 looks at the device 2100 with intention of controlling the device 2100.

On the contrary, when a user 2120 does not look at the device 2100 as shown in FIG. 21 (b), the validity conditions described in FIG. 20 cannot be satisfied. Therefore, according to the algorithm of the present invention, the device 2100 can determine that the user 2120 does not look at the device 2100 and thus, the user has no intention of controlling the device 2100.

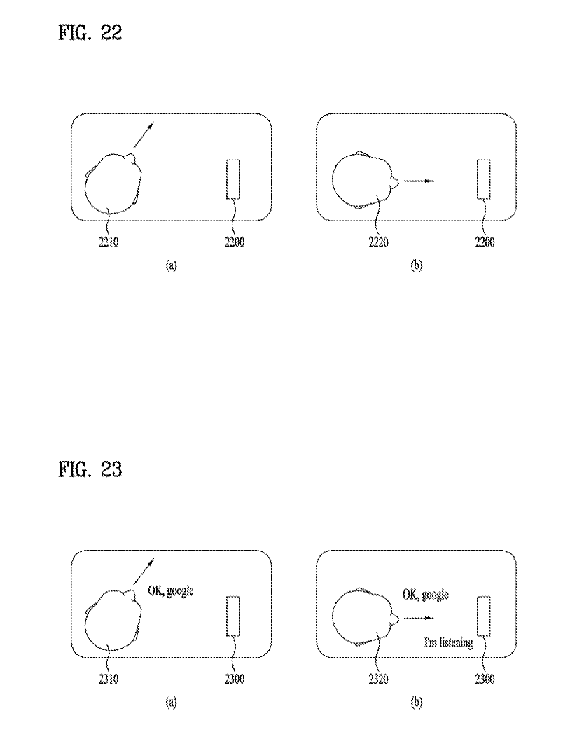

FIG. 22 is a diagram illustrating an example where the device changes its state according to directions of a user that desires to control the device according to an embodiment of the present invention. When a user 2210 does not look at a device 2200 as shown in FIG. 22 (a), the device 2200 is configured to turn off its screen.

Further, when recognizing that a user 2220 looks at the device 2200 as shown in FIG. 22 (b), the device 2200 is configured to display information on the weather, time, and notification by automatically turning on its screen. In addition, the device 2200 can automatically perform an unlock function through face recognition upon recognizing that a user looks at the device 2200 as shown in FIG. 22 (b).

FIG. 23 is a diagram illustrating another example where the device changes its state according to directions of a user that desires to control the device according to an embodiment of the present invention. When a user 2310 does not look at a device 2300 as shown in FIG. 23 (a), the device 2300 is designed not to recognize any voice commands from the user 2310. That is, it is possible to prevent a voice recognition engine from being driven.

Further, only when the device 2300 recognizes that a user 2320 looks at the device 2300, the device 2300 drives the voice recognition engine automatically and then outputs a result of the voice recognition for the user 2320 through the display unit or audio output module.

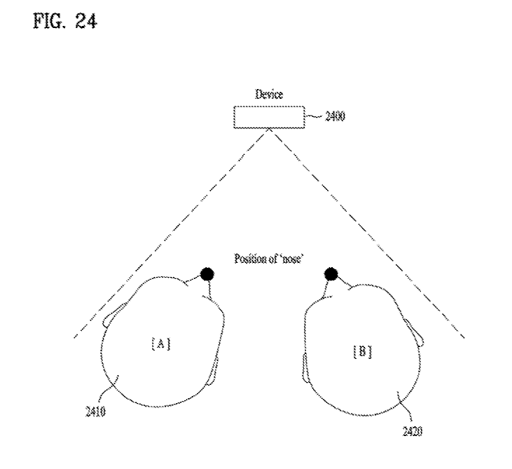

FIG. 24 is a diagram illustrating a solution for the case when a plurality of users desire to control the device according to an embodiment of the present invention. Hereinafter, a solution for the case when it is recognized that user 1 2410 shown in FIG. 24 (a) and user 2 2420 shown in FIG. 24 (b) look at a device 2400 will be described. Although, of course, the device 2400 can determine that a user with the minimum value related to his or her nose, i.e., the minimum z-value (i.e., minimum distance to the device 2400) will control the device 2400, various embodiments will be described with reference to FIG. 28.

FIG. 25 is a diagram illustrating a further example where the device changes its state according to directions of a user that desires to control the device according to an embodiment of the present invention. When it is recognized that a user 2510 looks at a device 2500 at the right side as shown in FIG. 25 (a), the device 2500 is configured to display a first GUI (menu). Further, when it is recognized that a user 2520 looks at the device 2500 at the left side, the device displays a second GUI. Here, not only is the first GUI different from the second GUI, but the amount of displayed data may be different.

FIG. 26 is a diagram illustrating still another example where the device changes its state according to directions of a user that desires to control the device according to an embodiment of the present invention. When it is recognized that a user 2610 looks at a device 2600 at the right side as shown in FIG. 26 (a), the device 2600 is configured to display an image of the right side of a 3D object, which is observed from the perspective of the user 2610. Further, when it is recognized that a user 2620 looks at the device 2600 at the left side as shown in FIG. 26 (b), the device 2600 is configured to display an image of the left side of a 3D object, which is observed from the perspective of the user 2620.

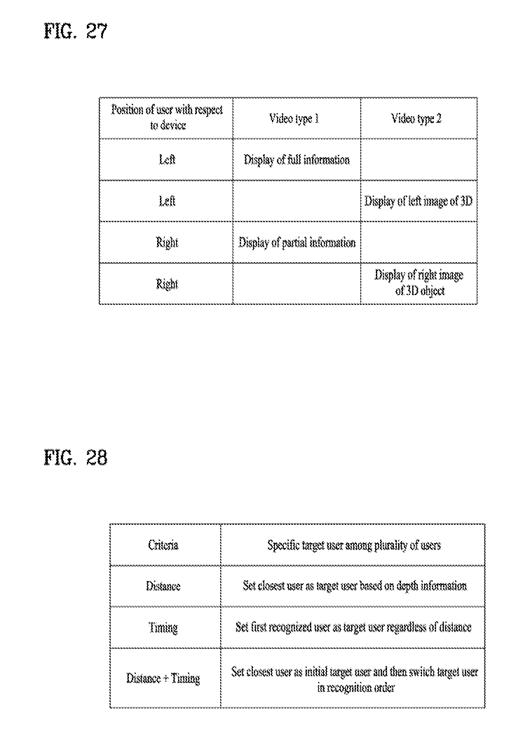

FIG. 27 is a diagram illustrating an example of metadata for changing the state of the device according to directions of a user that desires to control the device according to an embodiment of the present invention. The metadata in the database shown in FIG. 27 is configured to be pre-stored in the memory. For example, when a user is detected at the left side of the device to which the face recognition algorithm according to an embodiment of the present invention is applied, the device is configured to display video type 1 (e.g., full information) or video type 2 (e.g., left image of an 3D object).

Further, when a user is detected at the right side of the device to which the face recognition algorithm according to an embodiment of the present invention is applied, the device is configured to display video type 1 (e.g., partial information) or video type 2 (e.g., right image of an 3D object). That is, according to an embodiment of the present invention, different metadata can be used depending on whether the content displayed by the device is a 2D or 3D image.

FIG. 28 is a diagram illustrating another example of metadata for changing the state of the device according to directions of a user that desires to control the device according to an embodiment of the present invention. The metadata in the database shown in FIG. 28 is configured to be pre-stored in the memory. For example, when recognizing a plurality of users, the device to which the face recognition algorithm according to an embodiment of the present invention is applied determines a user with the shortest distance from the device as a target user.

Further, when recognizing a plurality of users, the device to which the face recognition algorithm according to an embodiment of the present invention is applied can determine the first recognized user as a target user. In addition, by considering all the above-described features, the device according to an embodiment of the present invention can initially determine the target user based on distances (depths) and then automatically switches the target user in the recognition order. That is, the present invention is not limited to one of the embodiments.

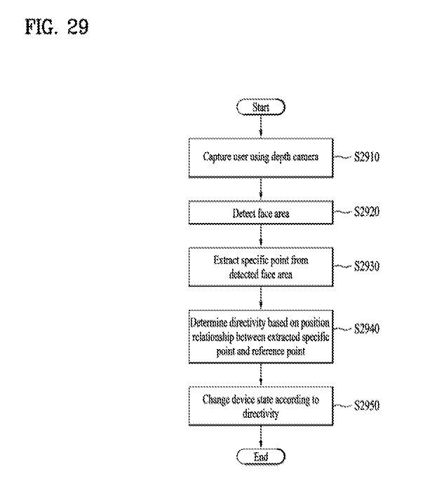

FIG. 29 is a flowchart illustrating a method for controlling the device according to another embodiment of the present invention. The aforementioned drawings may be used as complements of the flowchart illustrated in FIG. 29, and the main steps of the flowchart of FIG. 4 is summarized with reference to FIG. 29.

First, according to another embodiment of the present invention, a device with a depth camera captures at least one user using the depth camera (S2910). Next, the device detects a face area by analyzing an image of the captured user in accordance with at least one command stored in a memory (S2920).

In addition, the device extracts a specific point from the detected face area in accordance with the at least one command stored in the memory (S2930). In this instance, the at least one command may be some or all of the steps described above with reference to FIG. 4. Moreover, the device determines directivity of the at least one user based on a position relationship between the extracted specific point and a reference point in accordance with the at least one command stored in the memory (S2940).

Further, the device changes its state based on the directivity determination result in accordance with the at least one command stored in the memory (S2950). Step S2920 further includes: extracting a face candidate area from among objects in the image of the captured user; and if a specific index exists in the extracted face candidate area, determining that a face of the captured user is directed to the device. In this instance, the specific index corresponds to a point in the face candidate area where a change in the depth value on the x-axis is equal to or greater than a predetermined threshold value. Details can be found in the description made with reference to FIGS. 6 to 8.

Step 2930 further includes: calculating a position of a forehead and a position of a chin in the detected face area; determining a z-axis rotation direction and a y-axis rotation direction of the face of the user based on the calculated positions of the forehead and chin; and readjusting z-values among position values of individual points in the detected face area such that the calculated positions of the forehead and chin are perpendicular to the ground.

In this instance, readjusting is performed according to the following equation:

$${z}_{new} = z + ( {z}_{F} - {z}_{C} ) \times \frac{( y - {y}_{F} )}{( {y}_{C} - {y}_{F} )} .$$

In the above equation, Zf corresponds to an original z-coordinate value of the forehead before the position of the forehead is readjusted, Zc corresponds to an original z-coordinate value of the chin before the position of the chin is readjusted, Yf corresponds to an original y-coordinate value of the forehead before the position of the forehead is readjusted, and Yc corresponds to an original y-coordinate value of the chin before the position of the chin is readjusted. Details can be found in the description made with reference to FIGS. 12 to 16.

Step S2940 further includes: if a difference between an x-coordinate value of a specific point, which is determined to be closest to the device, and an x-coordinate value of the chin corresponding to a reference point is equal to or greater than a predetermined value, determining that the face of the user is directed to the device; and if the difference between the x-coordinate value of the specific point, which is determined to be closest to the device, and the x-coordinate value of the chin corresponding to the reference point is smaller than the predetermined value, determining that the face of the user is not directed to the device. Details can be found in the description made with reference to FIGS. 18 to 20.

Therefore, according to the above-described embodiments, not only is it possible to achieve high-speed close-range face recognition and tracking using a depth camera, but also a face interaction technology can be applied to various display devices including a mobile device, a TV, and the like.

The above-described invention can be implemented in a program-recorded medium as computer-readable codes. The computer-readable media may include all kinds of recording devices in which data readable by a computer system are stored. The computer-readable media may include HDD (hard disk drive), SSD (solid state disk), SDD (silicon disk drive), ROM, RAM, CD-ROM, magnetic tapes, floppy disks, optical data storage devices, and the like, for example and also include carrier-wave type implementations (e.g., transmission via Internet). Further, the computer may include the control unit 180 of the terminal device. Therefore, the above-mentioned embodiments are to be construed in all aspects as illustrative and not restrictive. The scope of the present invention should be determined by reasonable interpretation of the appended claims. In addition, the present invention covers the modifications and variations of this invention that come within the scope of the appended claims and their equivalents.

What is claimed is:

1. A method for controlling a device, the method comprising:
capturing, via a depth camera of the device, depth image data of a user;
detecting, via a controller of the device, a face area by analyzing the depth image data of the user;
extracting, via the controller, a specific point from the detected face area;
determining, via the controller, a direction the user is facing with respect to the device based on a position relationship between the extracted specific point and a reference point; and
changing, via the controller, a state of the device based on the determined direction the user is facing with respect to the device.

2. The method of claim 1, further comprising:
extracting a face candidate area from among objects in the captured depth image data of the user; and
if a specific index exists in the extracted face candidate area, determining that a face of the user is directed toward the device.

3. The method of claim 2, wherein the specific index corresponds to a point in the face candidate area where a depth change on an x-axis is equal to or greater than a predetermined threshold value.

4. The method of claim 1, further comprising:
calculating a position of a forehead and a position of a chin in the detected face area;
determining a z-axis rotation direction and a y-axis rotation direction of a face of the user based on the calculated positions of the forehead and chin; and
readjusting z-values among position values of individual points in the detected face area such that the calculated positions of the forehead and chin are perpendicular to the ground.

5. The method of claim 4, wherein the readjusting is performed according to the following equation:
$${z}_{new} = z + ( {z}_{F} - {z}_{C} ) \times \frac{( y - {y}_{F} )}{( {y}_{C} - {y}_{F} )} , \qquad ( Equation )$$
where Zf is an original z-coordinate value of the forehead before the position of the forehead is readjusted, Zc is an original z-coordinate value of the chin before the position of the chin is readjusted, Yf is an original y-coordinate value of the forehead before the position of the forehead is readjusted, and Yc is an original y-coordinate value of the chin before the position of the chin is readjusted.

6. The method of claim 1, further comprising:
if a difference between an x-coordinate value of the extracted specific point, which is determined to be closest to the device, and an x-coordinate value of a chin corresponding to the reference point is equal to or greater than a predetermined value, determining that a face of the user is directed toward the device; and
if the difference between the x-coordinate value of the extracted specific point, which is determined to be closest to the device, and the x-coordinate value of the chin corresponding to the reference point is smaller than the predetermined value, determining that the face of the user is not directed toward the device.

7. A device, comprising:
a depth camera configured to capture depth image data of a user;
a display; and
a controller configured to:
detect a face area by analyzing the depth image data of the user,
extract a specific point from the detected face area,
determine a direction the user is facing with respect to the device based on a position relationship between the extracted specific point and a reference point, and
display different video data on the display according to the determined user direction.

8. The device of claim 7, wherein when a plurality of users are detected, the controller is configured to analyze, as a target user, only a specific user among the recognized plurality of users based on depth information included in the captured depth image data or timing information.

9. The device of claim 8, wherein the controller is configured to switch the target user based on the depth information or the timing information.

10. The device of claim 7, wherein when the controller determines that the direction of the user is towards the device, the controller is configured to trigger a voice command function of the device or an unlock function through face recognition.

11. The device of claim 7, wherein when the controller determines the direction of the user is towards the device, the controller is configured to change the video data to be displayed according to a left and right directivity between the user and the device.

12. The device of claim 7, wherein the controller is further configured to:
extract a face candidate area from among objects in the captured image data of the user, and
if a specific index exists in the extracted face candidate area, determine that a face of the user is directed toward the device.

13. The device of claim 12, wherein the specific index corresponds to a point in the face candidate area where a depth change on an x-axis is equal to or greater than a predetermined threshold value.

14. The device of claim 7, wherein the controller is further configured to:
calculate a position of a forehead and a position of a chin in the detected face area,
determine a z-axis rotation direction and a y-axis rotation direction of a face of the user based on the calculated positions of the forehead and chin, and
readjust z-values among position values of individual points in the detected face area such that the calculated positions of the forehead and chin are perpendicular to the ground.

15. The device of claim 7, wherein the controller is further configured to:
if a difference between an x-coordinate value of the specific point, which is determined to be closest to the device, and an x-coordinate value of a chin corresponding to the reference point is equal to or greater than a predetermined value, determine that a face of the user is directed to the device, and
if the difference between the x-coordinate value of the specific point, which is determined to be closest to the device, and the x-coordinate value of the chin corresponding to the reference point is smaller than the predetermined value, determine that the face of the user is not directed to the device.

16. The device of claim 7, wherein the device is one of a mobile device, a television, and a display device.

17. The device of claim 7, wherein the depth camera corresponds to a sensor for detecting depth information using at least one of a time of flight (TOF), a stereoscopic vision, and a structured light pattern.
